(19) United States
(12) Patent Application Publication
(10) Pub. No.: US 2003/0193488 A1
(43) Pub. Date: Oct. 16, 2003

(54) Photo origami hexahedron

(76) Inventor: Heather N. Bean, Fort Collins, CO (US)

Correspondence Address: HEWLETT-PACKARD COMPANY, Intellectual Property Administration, P. O. Box 272400, Fort Collins, CO, 80527-2400, US

(21) Appl. No.: 10/394,119

(22) Filed: Mar. 20, 2003

Related U.S. Application Data
(62) Division of application No. 09/772,754, filed on Jan. 29, 2001, now abandoned.

(51) Int. Cl. G09G 5/00

(52) U.S. Cl. 345/204

(57) ABSTRACT

A method and apparatus for printing photo's on a page to create a photo “cube” using origami.

### FIELD OF THE INVENTION

The present invention relates generally to printer paper and more specifically to printer paper and a printer template for creating a disposable photo “cube”.

### BACKGROUND OF THE INVENTION

People like to keep photos of their family, friends, pets, etc. on their desks and tables so they and others can look at them easily. This is often accomplished through a clear, hollow plastic cube with foam in the middle. Pictures can be inserted on the sides and the top of the cube and are held pressed against the sides by the foam. This can sometimes be difficult, as most photos don't come in exactly the right size to fit the cube and must be cut. The cube can also get scratched and battered over time, degrading the appearance of the pictures.

What is needed is a method and apparatus to easily display photos. The apparatus needs to be cheap and easy enough to use such that, when it gets damaged, you can throw it away and make a new one.

### SUMMARY OF THE INVENTION

A method and apparatus for printing photo's on a page to create a photo “cube” using origami, or paper folding.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a drawing of the crease lines and photo areas for a single page used to create a photo hexahedron with one open face in accordance with the current invention.

FIG. 2 is a drawing of a folded photo hexahedron in accordance with the current invention.

### DETAILED DESCRIPTION OF THE PREFERRED EMBODIMENT

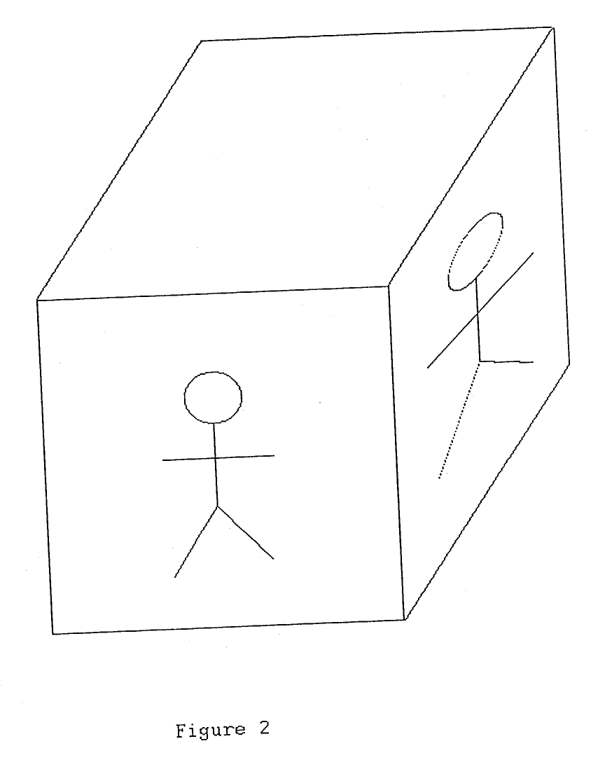

A relatively inexpensive photo display method that does not require cutting the photos will allow a user to easily display photos on their desks. A user that has images in digital form, from a digital camera, a scanner, or some other method, can quickly create a photo “cube” using the current invention. In this application a photo “cube” means any hexahedron shape with one open face. An open face means that there would not be any paper occupying that face of the hexahedron, thereby leaving an opening into the structure. Using this method a user would select 5 images and drag and drop the images onto a template. The template would automatically scale and orient the images. Scaling may be done isometrically or non-isometrically. It is well known in the art how to scale an image to fit a predefined rectangular space. The template would orient the images such that once the page has been folded, four of the image bottoms would be adjacent to the open face of the hexahedron (see FIG. 2). Once the user has selected the 5 images and loaded the template the user can print a page. Once the page has been printed the user can create a photo “cube”, using origami, by folding the page.

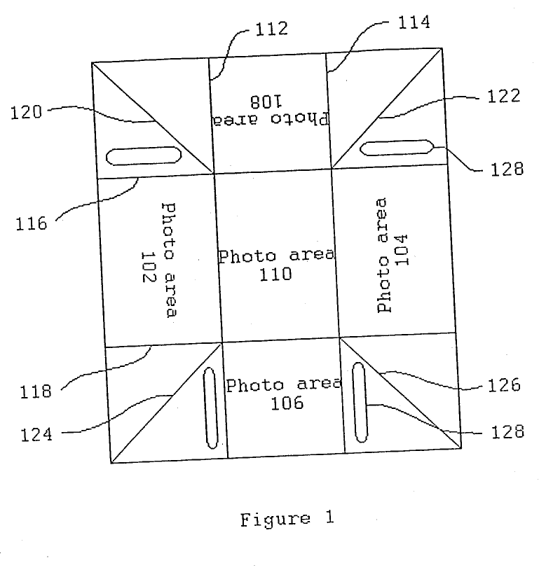

The paper that is used to print the page can be ordinary paper or the paper can be pre-creased. The pre-creased paper would have creases where the user would fold the paper to create the hexahedron (see FIG. 1). The pre-creased paper may come with adhesive (128) or some other mechanism for holding the hexahedron in place, once the user has folded the page. When ordinary paper is used, the user would have an option of printing fold line, along with the images, onto the page.

The foregoing description of the present invention has been presented for purposes of illustration and description. It is not intended to be exhaustive or to limit the invention to the precise form disclosed, and other modifications and variations may be possible in light of the above teachings. Other method can be used, for example a paper clip or piece of tape can be used to hold the hexahedron in place. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for printing photos on a single page to create a photo hexahedron using origami, comprising:
choosing five images;
arranging the five images on the single page such that the five images occupy five faces of a hexahedron when the single page is folded into a hexahedron with one open face;
aligning the four images that occupy the four faces of the hexahedron adjacent to the open face such that the bottom of the images are adjacent to the open face.

2. The method of claim 1 where the single-page is pre-creased along the lines to be folded.

3. The method of claim 1 where the single-page has adhesive in the areas that are folded together.

4. The method of claim 1 where fold lines are printed on the page along with the images.

5. A template for arranging five images on a single page to create a photo hexahedron using origami, comprising:
a template area that fits onto a single page, the template area having a top edge, a right edge, a left edge and a bottom edge;
the template area divided into three vertical bands, a top band, a middle band and a bottom band;
the top band is divided into three areas, a top right area, a top center area, and a top left area;
the top center area is for the placement of one of the images with the image oriented such that the bottom of the image is along the top edge of the template area;
the middle band is divided into three areas, a left middle area, a right middle area, and a center middle area;
the left middle area is for the placement of one of the images with the image oriented such that the bottom of the image is along the left edge of the template area;
the right middle area is for the placement of one of the images with the image oriented such that the bottom of the image is along the right edge of the template area;
the center middle area is for the placement of one of the images;
the bottom band is divided into three areas, a bottom right area, a bottom center area, and a bottom left area;
the bottom center area is for the placement of one of the images with the image oriented such that the bottom of the image is along the bottom edge of the template area.

6. A page pre-creased to create a photo hexahedron using origami, comprising:
the page having a top, a bottom, a right side, a left side, a top right corner, a top left corner, a bottom right corner, and a bottom left corner;
a first crease running vertically from the top of the page to the bottom of the page, with the first crease placed a predetermined distance from the left side;
a second crease running vertically from the top of the page to the bottom of the page, with the second crease placed a predetermined distance from the right side;
a third crease running horizontally from the left side to the right side, with the third crease placed a predetermined distance from the top of the page;
a fourth crease running horizontally from the left side to the right side, with the fourth crease placed a predetermined distance from the bottom of the page.

7. The page of claim 6 further comprising:
a fifth crease running from the intersection of the first crease and the third crease to the top left corner of the page;
a sixth crease running from the intersection of the first crease and the fourth crease to the top right corner of the page;
a seventh crease running from the intersection of the second crease and the third crease to the bottom left corner of the page;
an eighth crease running from the intersection of the second crease and the fourth crease to the bottom right corner of the page.

8. The page of claim 7 where there is adhesive between crease 1 and 5, and between. crease 1 and 6, and between 2 and 8, and between crease 2 and 7.
